(19) United States
(12) Patent Application Publication
(10) Pub. No.: US 2002/0125711 A1
(43) Pub. Date: Sep. 12, 2002

(54) Germ shields for wheelchairs

(76) Inventor: William H. Calhoun, Shreveport, LA (US)

Correspondence Address: R. Keith Harrison, 2139 E. Bert Kouns, Shreveport, LA, 71105, US

(21) Appl. No.: 10/081,600

(22) Filed: Feb. 20, 2002

Related U.S. Application Data
(60) Provisional application No. 60/273,600, filed on Mar. 7, 2001.

(51) Int. Cl. B62B 9/14

(52) U.S. Cl. 280/848; 280/250.1

(57) ABSTRACT

Germ shields which can be retro-fitted to existing wheelchairs or included in the design of a typically manually-propelled wheelchair to prevent contamination or soiling of the sleeves of a user by contact of the shirt sleeves with the large wheels of the wheelchair as the user propels himself or herself in the wheelchair. The germ shields of the present invention are broadly characterized by an elongated, arcuate cover which engages the wheelchair and covers a substantial upper curvature or portion of a large wheel on the wheelchair.

### CROSS-REFERENCE TO RELATED APPLICATIONS

This application claims the benefit of provisional application No. 60/273,600, filed Mar. 7, 2001.

### BACKGROUND OF THE INVENTION

### Field of the Invention

The present invention relates to accessories for wheelchairs, and more particularly, to germ shields which can be retro-fitted to existing wheelchairs or built-in as a component part of a typically manually-propelled wheelchair to prevent contamination or soiling of the sleeves of a user by contact of the shirt sleeves with the large wheels of the wheelchair as the user propels himself or herself in the wheelchair. The germ shields of the present invention are broadly characterized by an elongated, arcuate cover which engages the wheelchair and covers a substantial upper curvature or portion of a large wheel on the wheelchair.

Conventional manual wheelchairs typically include a frame which is made portable by a pair of large rear wheels and a pair of small, swivally-mounted front wheels which steer the frame. Armrests are provided above the respective large wheels for supporting the arms of a patient as he or she sits in the wheelchair. Each large wheel is fitted with an outwardly-extending, smaller-diameter grip rim for use by the patient in gripping and propelling the wheelchair as the patient sits in the wheelchair.

One of the problems often encountered by patients using manual wheelchairs is that the large wheels pick up dirt, germs and other contaminants as they roll along the ground. The sleeves of the patient's shirt tend to brush against the contaminated wheels as the patient grips and rotates the grip rims on the wheels. As a result, the contaminants tend to soil the patient's clothing.

Accordingly, an object of the present invention is to provide germ shields which may be retro-fitted to existing wheelchairs or built into the wheelchair as a component part to partially cover a large wheel of a wheelchair.

Another object of the present invention is to provide germ shields which are capable of preventing contamination or soiling of a patient's arms, hands, clothing or other articles by the wheelchair wheels or can be used for any other suitable purpose as the patient propels himself or herself in the wheelchair.

Still another object of the present invention is to provide germ shields of various design which can be removably or fixedly attached to a manual or electric wheelchair by any of a variety of techniques.

Yet another object of the present invention is to provide germ shields which can be constructed of plastic, metal, fiberglass or any other suitable material.

### SUMMARY OF THE INVENTION

These and other objects of the invention are provided in germ shields which can be retro-fitted to existing wheelchairs or included as a component part in manually-propelled or electric wheelchairs to prevent contamination or soiling of the hands, arms, clothing or other articles of a user by contact with the large wheels of the wheelchair as the user propels himself or herself in the wheelchair. The germ shields of the present invention typically include an elongated, arcuate cover which engages the wheelchair and covers a substantial portion of the upper curvature of a corresponding large wheel on the wheelchair.

### BRIEF DESCRIPTION OF THE DRAWINGS

The invention will be better understood, by way of example, with reference to the accompanying drawings, wherein:

FIG. 1 is a side view of a conventional manual wheelchair (in phantom), with a germ shield of the present invention (in solid lines) mounted on the wheelchair;

FIG. 1A is a rear view of the germ shield illustrated in FIG. 1;

FIG. 2 is a front view of a wheelchair with germ shield, in which two germ shields, each illustrated in cross-section, are built into respective sides of the wheelchair;

FIG. 2A is a side view, partially in section, of a wheelchair with germ shield illustrated in FIG. 2;

FIG. 3 is an exploded side view of another embodiment of the germ shield, more particularly illustrating a typical technique for mounting the germ shield on the wheel axle of a wheelchair;

FIG. 4 is a rear view of the germ shield illustrated in FIG. 3;

FIG. 5 is a side view of a wheelchair (in phantom), with still another embodiment of the germ shield (illustrated in solid lines) mounted on the wheelchair;

FIG. 6 is an exploded view of the germ shield illustrated in FIG. 5, removed from the wheel axle;

FIG. 7 is a side view of yet another embodiment of the germ shield, with the germ shield mounted over a large wheel (in phantom) of a wheelchair; and

FIG. 8 is a sectional view, taken along section lines 8-8 in FIG. 7, of another embodiment of the germ shield of the present invention.

### DESCRIPTION OF THE PREFERRED EMBODIMENTS

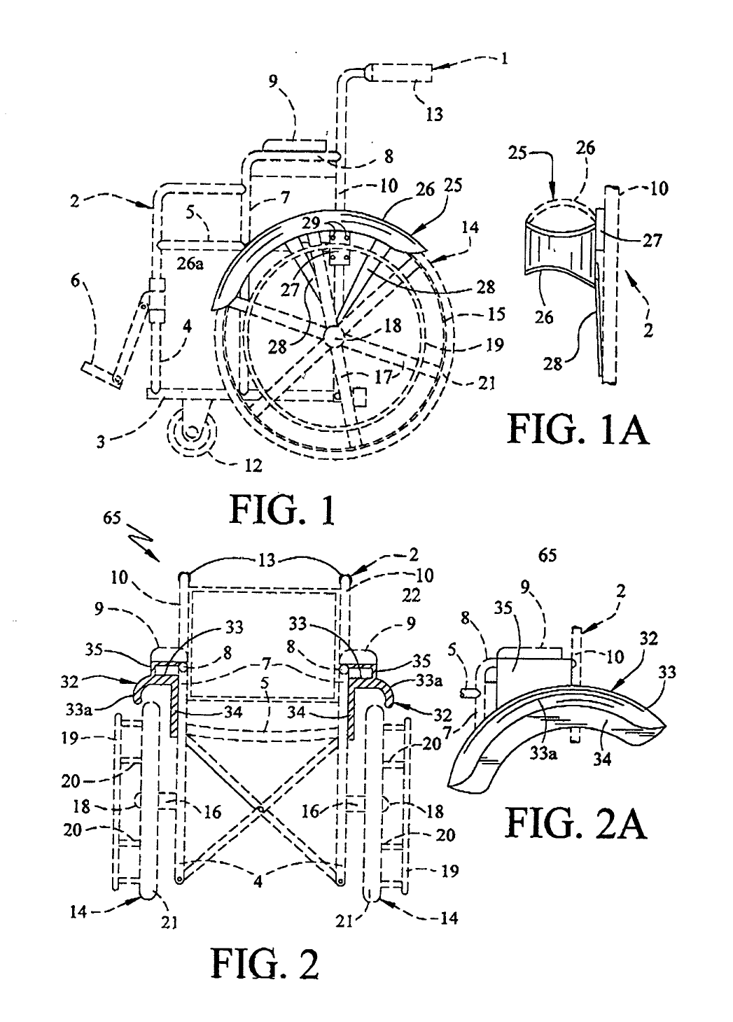

Referring initial to FIG. 1 of the drawings, a typical conventional manual wheelchair 1 is shown in phantom and typically includes a wheelchair frame 2, having a pair of horizontal bottom fame members 3 (one of which is shown) and a pair of vertical front frame members 4 extending upwardly from the front ends of the respective bottom frame members 3. A pair of vertical rear frame members 10 extends upwardly from the rear ends of the respective bottom frame members 3, and a pair of vertical middle frame members 7 extends upwardly from approximately the midpoint of each bottom frame member 3. A seat 5 is mounted between the front frame members 4, the middle frame members 7 and the rear frame members 10. An armrest 8 typically extends horizontally from each vertical middle frame member 7, and supports an armrest pad 9 thereon Each rear frame member 10 is typically fitted with a push handle 13. A footrest 6 may be provided on the front frame members 4 for supporting the feet (not illustrated) of a patient or other user as the user sits on the seat 5. A back support 22 (FIG. 2) typically spans the rear frame members 10.

The conventional wheelchair 1 further includes a pair of small front wheels 12, which are swivally mounted on the wheelchair frame 2 and function to steer the wheelchair 1, and a pair of large rear wheels 14. Each rear wheel 14 is mounted on a horizontal axle 16 (FIG. 2), typically beneath the corresponding armrest 8, and typically includes a rim 15 fitted with a rubber tire 21 and connected to a hub 18 by means of multiple spokes 17. An annular grip rim 19 is fitted on multiple grip rim supports 20 (FIG. 2) which extend outwardly from the rear wheel 14 to enable a user seated in the wheelchair 1 to grip and rotate the grip rim 19 and propel himself or herself in the wheelchair 1, in conventional fashion.

Referring next to FIGS. 1 and 1A of the drawings, an illustrative embodiment of a germ shield of the present invention is generally indicated by reference numeral 25. Each of two germ shields 25 is typically mounted on a corresponding side of the wheelchair frame 2 to cover or shield a portion of the tire 21 corresponding to the upper curvature of each rear wheel 14, as shown in FIG. 1 and hereinafter further described. Each germ shield 25 includes a generally elongated, arcuate cover 26 which may be constructed of plastic, metal, fiberglass or any other suitable material. As illustrated in FIG. 1A, while the cover 26 typically has a generally curved cross-sectional configuration, it is understood that the cover 26 may have any alternative cross-sectional configuration capable of covering or shielding the tire 21. At least two mount arms 28 extend downwardly from the cover 26, and the extending end of each mount arm 28 is bolted, welded or otherwise attached to the corresponding rear frame member 10 of the wheelchair frame 2, as further illustrated in FIG. 1A. Accordingly, the generally arcuate longitudinal configuration of the cover 26 substantially matches the upper curvature of the rear wheel 14 on the wheelchair 1 and covers the tire 21 corresponding to that portion of the rear wheel 14 in spaced-apart relationship to the tire 21 to facilitate free and non-hindered rotation of the rear wheel 14 through the cover 26. As further illustrated in FIGS. 1 and 1A, in addition to the mount arms 28, a mount bracket 27 may extend downwardly from the side or longitudinal edge of the cover 26 which is disposed adjacent to the wheelchair frame 2, to further secure or stabilize the cover 26 on the wheelchair frame 2. The mount bracket 27 may be attached to the wheelchair frame 2 by means of mount bolts 29, as illustrated in FIG. 1, or by any alternative technique known by those skilled in the art.

In typical application of the germ shields 25, a patient or other user (not illustrated) sits on the seat 5 in the wheelchair 1 with his or her feet typically resting on the footrest 6. As the user grips the grip rims 19 extending outwardly from the respective rear wheels 14 and pushes against the grip rims 19 to propel the wheelchair 1 forwardly or rearwardly in conventional fashion, the cover 26 of each germ shield 25 prevents the arms, hands, shirt sleeves, or other clothing or articles (not illustrated) of the user from inadvertently contacting the tires 21 of the respective rear wheels 14. Accordingly, contaminants such as bacteria and dirt picked up by the tires 21 as the tires 21 traverse the floor or ground (not illustrated) are prevented from contaminating or soiling the patient's arms, hands, clothing or articles.

Referring next to FIGS. 2 and 2a of the drawings, a wheelchair with germ shields of the present invention is generally indicated by reference numeral 65 and includes two germ shields 32 which are built into the wheelchair frame 2 on respective sides of the wheelchair 65. The wheelchair 65 may have the same structural characteristics as the conventional wheelchair 1 heretofore described with respect to FIG. 1, except that rather than being retro-fitted to the existing conventional wheelchair 1, the germ shields 32 are built into or constructed integrally with the typically conventional wheelchair 1 to define the wheelchair with germ shields 65. Each germ shield 32 includes a generally elongated, arcuate cover 33 which includes an outwardly-extending, longitudinal curved portion 33a along the outer edge of the cover 33, as illustrated in FIG. 2. An armrest mount bracket 35 extends upwardly from the upper surface of the cover 33 and may be attached to the bottom surface of the corresponding armrest pad 9, to the armrest 8, to both the armrest pad 9 and the armrest 8, or to any or all of those elements and/or any other suitable element of the wheelchair frame 2 by means of bolts (not illustrated) or any other suitable technique known by those skilled in the art. Alternatively, the armrest mount bracket 35 may be molded or otherwise constructed integrally with the armrest pad 9, armrest 8, armrest pad 9 and armrest 8, or to any or all of those elements and/or any other suitable element of the wheelchair frame 2. A frame mount bracket 34 may additionally extend downwardly from the inside edge of the cover 33, and is attached typically to the rear frame member 10, to the middle frame member 7, to the armrest 8 and/or to any other structural element of the wheelchair frame 2, typically by means of bolts (not illustrated) or any other suitable technique known by those skilled in the art. As further illustrated in FIG. 2A and heretofore described with respect to the germ shield 25 of FIG. 1, the arcuate configuration of the cover 33 substantially matches the curved contour of the upper portion of the corresponding rear wheel 14 of the wheelchair 65, and is spaced from the tire 21 of the corresponding rear wheel 14 as illustrated in FIG. 2 to facilitate free and unhindered rotation of the rear wheel 14 through the cover 33. Accordingly, the cover 33 of each germ shield 32 prevents bacteria, dirt and other contaminants picked up by the tire 21 of the rear wheel 14 from soiling or contaminating the hand, arm, clothing, or articles of a wheelchair user as the user sits and propels himself or herself in the wheelchair 65 using the grip rims 19.

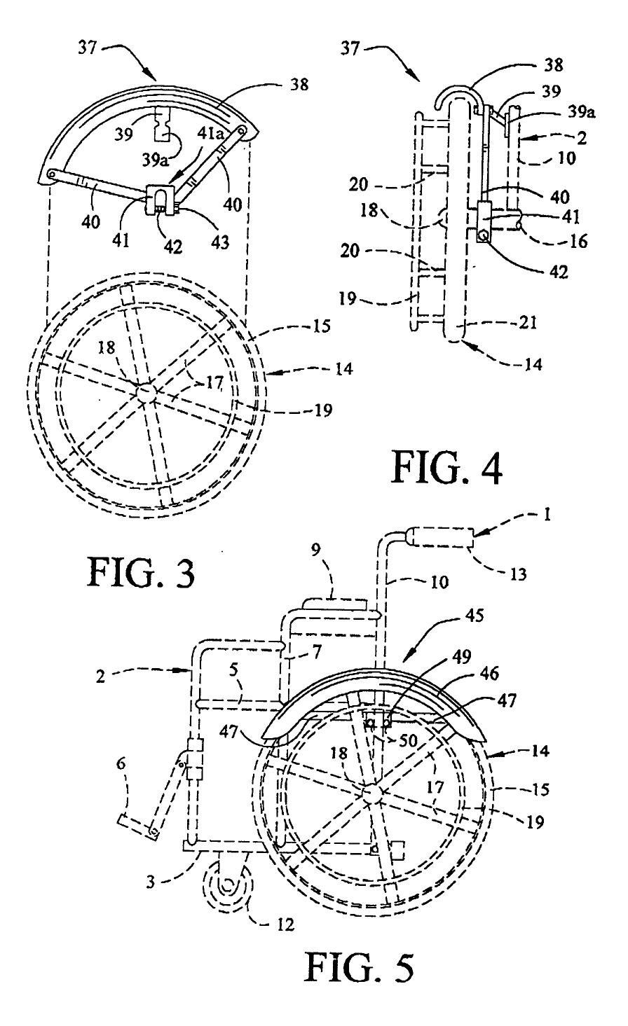

Referring next to FIGS. 3 and 4 of the drawings, in still another embodiment a germ shield of the present invention is generally indicated by reference numeral 37 and is designed for typically removable attachment to the wheelchair 1 (FIG. 1), which may be conventional. The germ shield 37 includes a generally elongated, arcuate cover 38, which typically has a generally arcuate, curved or semicircular cross-sectional configuration as illustrated in FIG. 4 but may have any other configuration suitable for substantially covering or shielding the tire 21 of the rear wheel 14. Each of a pair of axle mount arms 40 angles toward the other from a corresponding end of the cover 38 and is attached to the cover 38 typically at the inside edge thereof as illustrated in FIG. 4. The axle mount arms 40 converge on a typically U-shaped axle mount bracket 41 having a bracket opening 41a for receiving the axle 16 of the wheelchair 1, as illustrated in FIG. 4. A bracket bolt 42 extends through aligned bolt openings (not illustrated) provided in the axle mount bracket 41 and receives a securing nut 43 to facilitate removably, yet securely, mounting the axle mount bracket 41 on the axle 16. A frame mount arm 39, typically fitted with a mount bracket 39a, typically extends from the cover 38 between the axle mount arms 40 for bolted or other fixed or removable attachment of the mount bracket 39a to the rear frame member 10 or to any other suitable structural element of the wheelchair frame 2. When the germ shield 37 is so mounted on the wheelchair frame 2, as illustrated in FIG. 4, the cover 38 of the germ shield 37 is spaced from the tire 21 of the rear wheel 14 to facilitate free and unhindered rotation of the rear wheel 14 through the cover 38, and the cover 38 of each germ shield 37 prevents inadvertent contact of the tire 21 of the corresponding rear wheel 14 with the hand, arm, clothing, or articles of a patient (not illustrated) during use of the wheelchair 1.

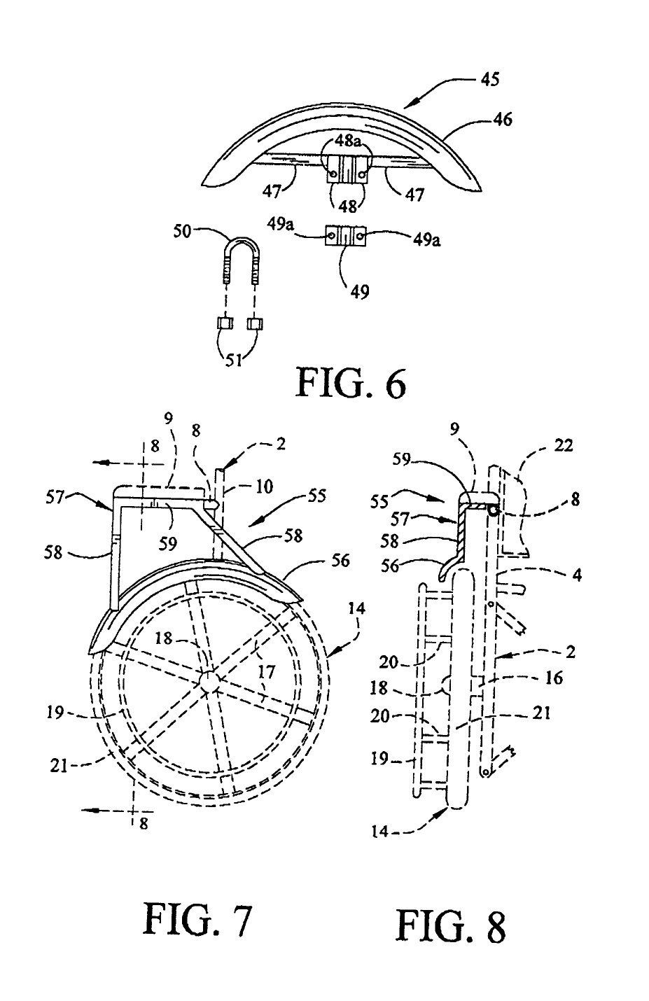

Referring next to FIGS. 5 and 6 of the drawings, yet another embodiment of the germ shield of the present invention is generally indicated by reference numeral 45 and includes the generally elongated, arcuate cover 46, and a pair of mount arms 47 extends generally horizontally inwardly toward each other from respective ends of the cover 46. A generally horizontal mount bracket 48, fitted with a bolt opening 48a, terminates the end of each mount arm 47. A bracket plate 49, provided with spaced-apart bolt openings 49a, is used in conjunction with a threaded U-bolt 50 and securing nuts 51 to facilitate securing the germ shield 45 on the wheelchair 1. Accordingly, each germ shield 45 is mounted on the corresponding rear frame member 10 of the wheelchair frame 2 by initially positioning the mount brackets 48 on respective sides of the rear frame member 10; extending the U-bolt 50 through the respective bolt openings 48a such that the U-bolt 50 extends on respective sides of the rear frame member 10; extending the U-bolt 50 through the respective bolt openings 49a of the bracket plate 49; and threading the securing nuts 51 on the U-bolt 50 and tightening the nuts 51 against the bracket plate 49. In the foregoing manner, the germ shield 45 is mounted on the wheelchair 1, with the cover 46 substantially covering the upper curvature of the rear wheel 14 to prevent inadvertent contact of the tire 21 of the rear wheel 14 with the hand, arm, clothing, or articles of a patient (not illustrated) during use of the wheelchair 1.

Referring next to FIGS. 7 and 8 of the drawings, yet another embodiment of the germ shield of the present invention is generally indicated by reference numeral 55 and includes a generally elongated, arcuate cover 56 which is fitted with a mount frame 57 for mounting on the the armrest 8, armrest pad 9 or other suitable element of the wheelchair frame 2. The mount frame 57 typically includes a pair of mount arms 58 which extend from the cover 56, and a mount bracket 59 spans the mount arms 58. The mount bracket 59 of the mount frame 57 is fixedly or removably attached to the armrest 8, to the armrest pad 9 or to any other suitable element of the wheelchair frame 2 by means of bolts (not illustrated) or any other suitable attachment mechanism. Accordingly, the cover 56 of the germ shield 55 shields the upper portion of the tire 21 of the rear wheel 14 in such a manner that the patient's hand, arm, clothing or articles are incapable of contacting the tire 21 as the patient propels himself or herself in the wheelchair 1.

It will be appreciated by those skilled in the art that the germ shields of the present invention, while particularly useful for preventing contamination or soiling of the hands, arms, clothing or articles of a patient using a manual wheelchair, is equally applicable to both manual and electric wheelchairs for the same or other purposes. Furthermore, the germ shields may be constructed of plastic, metal, fiberglass, wood or any other desired material. It is understood that both the conventional manual wheelchair 1 and the wheelchair with germ shields 65 of the present invention may have a design which differs from that heretofore described with respect to FIGS. 1 and 2, respectively, the above descriptions being just one of multiple designs for manual wheelchairs which are suitable for implementation of the germ shields of the present invention. It is further understood that the shapes of the germ shields in the various embodiments described above may have shapes or configurations that depart from those illustrated in the drawings.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, I claim:

1. A germ shield for covering an upper portion of a wheel on a wheelchair having a frame, armrests and a wheel axle for mounting the wheel, said germ shield comprising:
an elongated, substantially arcuate cover for substantially covering the upper portion of the wheel; and
at least one mount element carried by said cover for engaging the wheelchair and supporting said cover on the wheelchair.

2. The germ shield of claim 1 wherein said at least one mount element comprises a mount bracket.

3. The germ shield of claim 1 wherein said at least one mount element comprises at least one mount arm.

4. The germ shield of claim 3 wherein said at least one mount element further comprises a mount bracket.

5. The germ shield of claim 1 wherein said cover is constructed of plastic.

6. The germ shield of claim 5 wherein said at least one mount element comprises a mount bracket.

7. The germ shield of claim 5 wherein said at least one mount element comprises at least one mount arm.

8. The germ shield of claim 7 wherein said at least one mount element comprises a mount bracket.

9. The germ shield of claim 1 wherein said at least one mount element comprises a pair of axle mount arms carried by said cover and an axle mount bracket carried by said pair of axle mount arms for engaging the wheel axle of the wheelchair.

10. The germ shield of claim 9 wherein said at least one mount element further comprises a frame mount arm carried by said cover for engaging the frame of the wheelchair.

11. The germ shield of claim 9 wherein said cover is constructed of plastic.

12. The germ shield of claim 11 wherein said at least one mount element further comprises a frame mount arm carried by said cover for engaging the frame of the wheelchair.

13. The germ shield of claim 1 wherein said at least one mount element comprises a pair of mount arms extending toward each other from said cover; a pair of mount brackets carried by said pair of mount arms, respectively, a bracket plate; and a fastener for engaging said pair of mount brackets and said bracket plate and removably engaging the frame of the wheelchair.

14. The germ shield of claim 13 wherein said cover is constructed of plastic.

15. A germ shield for covering an upper portion of a wheel on a wheelchair having a frame, armrests and a wheel axle for rotatably mounting said wheel, said germ shield comprising:
a substantially arcuate cover for substantially covering the upper portion of the wheel; and
a mount frame carried by said cover for engaging the wheelchair and supporting said cover on the wheelchair, said mount frame including at least one mount arm extending from said cover and a mount bracket carried by said at least one mount arm for engaging the frame of the wheelchair.

16. The germ shield of claim 15 wherein said at least one mount arm comprises a pair of mount arms extending from said cover in spaced-apart relationship to each other and wherein said mount bracket spans said pair of mount arms.

17. The germ shield of claim 15 wherein said cover is constructed of plastic.

18. The germ shield of claim 17 wherein said at least one mount arm comprises a pair of mount arms extending from said cover in spaced-apart relationship to each other and wherein said mount bracket spans said pair of mount arms.

19. A wheelchair comprising:
a frame;
a pair of wheels provided on said frame;
a pair of armrests provided on said frame above said pair of wheels, respectively;
a pair of germ shields at least partially covering an upper curvature of said pair of wheels, respectively, said pair of germ shields each comprising a substantially arcuate cover disposed adjacent to said upper curvature of a corresponding one of said pair of wheels and carried by said frame beneath a corresponding one of said pair of armrests.

20. The wheelchair of claim 19 comprising a frame mount bracket provided on said cover for engaging said frame and an armrest mount bracket provided on said cover for engaging said corresponding one of said pair of armrests.
